(19) United States
(12) Patent Application Publication
(10) Pub. No.: US 2011/0048548 A1
(43) Pub. Date: Mar. 3, 2011

(54) Filter switching apparatus

(76) Inventor: Thomas Rahm, Truman, MN (US)

(21) Appl. No.: 12/802,739

(22) Filed: Jun. 11, 2010

Related U.S. Application Data
(60) Provisional application No. 61/268,362, filed on Jun. 11, 2009.

(51) Int. Cl. F15D 1/00

(52) U.S. Cl. 137/351; 137/545

(57) ABSTRACT

A filter switching apparatus detects when a first diesel fuel filter becomes clogged and switches to a secondary filter either automatically or via user control.

### PRIORITY CLAIM

This application claims priority to U.S. provisional patent application No. 61/268,362 entitled “Filter Switching Apparatus” filed on Jun. 11, 2009.

### FIELD OF THE INVENTION

The present invention relates to fuel filters for diesel engines More particularly, the present invention relates to a filter switching apparatus for diesel engines.

### BACKGROUND OF THE INVENTION

Biodiesel fuels have several advantages over diesel fuel derived solely from petrochemicals. However, biodiesels may contain contaminants that are likely to clog fuel filters. The increased use of biodiesel fuels provides an impetus for improved filtering technology.

### BRIEF DESCRIPTION OF THE INVENTION

A filter switching apparatus detects when a first diesel fuel filter becomes clogged and switches to a secondary filter either automatically or via user control.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 depicts a first embodiment of the filter switching apparatus with filters attached.

FIGS. 2A, 2B, 2C and 2D are engineering drawings depicting a first embodiment of various aspects of the invention.

FIG. 3 is schematic depicting configuration of the filters and valves in an embodiment of the invention having two filters.

FIGS. 4A, 4B, 4C, 4D, 4E, 4F, and 4G are engineering drawings of a first embodiment of the manifold.

FIG. 5 is a front view of a working prototype of a first embodiment of the invention.

FIG. 6 is a rear view of a working prototype of a first embodiment of the invention.

FIG. 7 depicts a second embodiment of the filter switching apparatus with filters attached.

FIGS. 8A, 8B, 8C, 8D, 8E, 8F and 8G are engineerings drawing of a second embodiment of the manifold. The drawings are to scale. The width of the manifold as shown in 7.75 inches.

FIG. 9A is an engineering drawing of a second embodiment of the manifold. FIG. 9B is a cross-sectional view of a valve assembly and cartridge sleeve. FIG. 9C is a sectional view of the manifold showing the location of the vacuum/pressure switch and pressure equalizing port.

FIGS. 10A, 10B and 10C are engineering drawings of a cartridge sleeve.

FIGS. 11A and 11B shows schematics of embodiments of filter switching control units.

FIGS. 12A and 12B depict an air separator.

FIGS. 13A, 13B and 13C depict a mounting bracket for mounting the device in the engine compartment of a vehicle.

FIG. 14 is a depiction of and embodiment of the cover of the electronics bay.

FIG. 15 depicts a heating blanket for a fuel filter.

### DETAILED DESCRIPTION

Embodiments of the present invention are described herein in the context of a fuel filter switching device. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

A filter switching apparatus for diesel fuel applications permits automatic and/or semiautomatic switching between filters. When configured for two filters, the apparatus includes a fluid routing block (or “manifold”) on which a first filter and a secondary filter may be mounted, a valve system, a fuel supply line sensor, a filter switching control unit, and a filter priming pump. A monitoring unit and various other accessories may also be included. The fluid routing block has an inlet for receiving unfiltered fuel, an output for outputting filtered fuel, a first filter mounting area, a secondary filter mounting area, and passageways within the block for directing fuel through either the first or secondary filters. The routing block also has passageways and outlets for drains lines used in priming the filters. A valve system selectively directs the flow of unfiltered fuel to one or the other of the filters. During normal operation, the valve system initially directs fuel to the first filter. During “backup” operation, the valve system directs fuel to the secondary filter.

In practice, the designation of a first filter and a secondary filter is arbitrary, as either mounting position can be the filter in operation with the other mounting position serving as the backup.

The valve system is controlled by a switch, which is in turn controlled by a fuel supply line sensor. The fuel supply line sensor may be a vacuum sensor or a pressure sensor. When a vacuum sensor is employed, the sensor monitors the strength of any vacuum in the fuel supply line to detect when the vacuum exceeds a predetermined threshold. If the threshold is exceeded, the vacuum switch sends a signal to the filter switching control unit. When set to automatic mode, the control unit sends signals to modify the position of the valve system to disable the first filter and enable the secondary filter. The operation is similar when a pressure sensor is used.

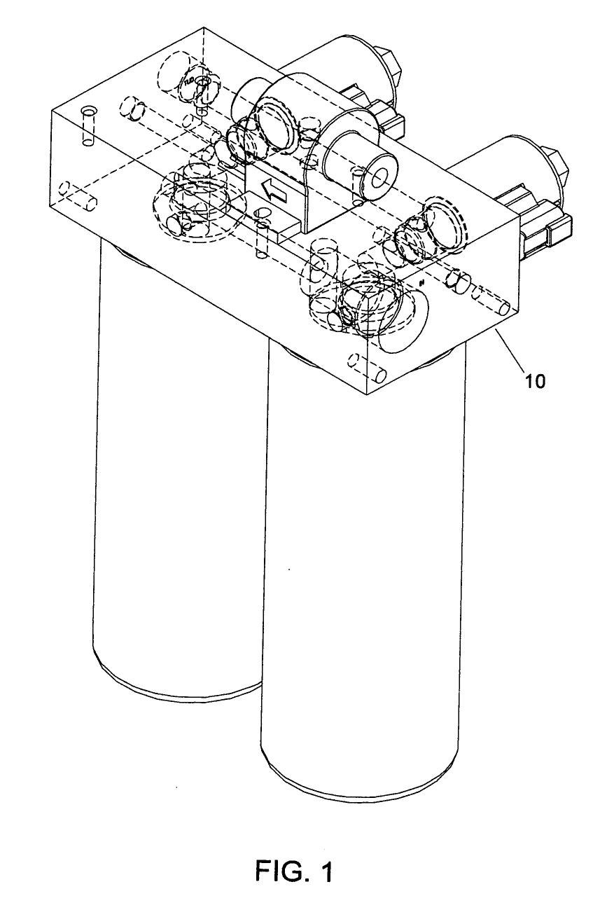

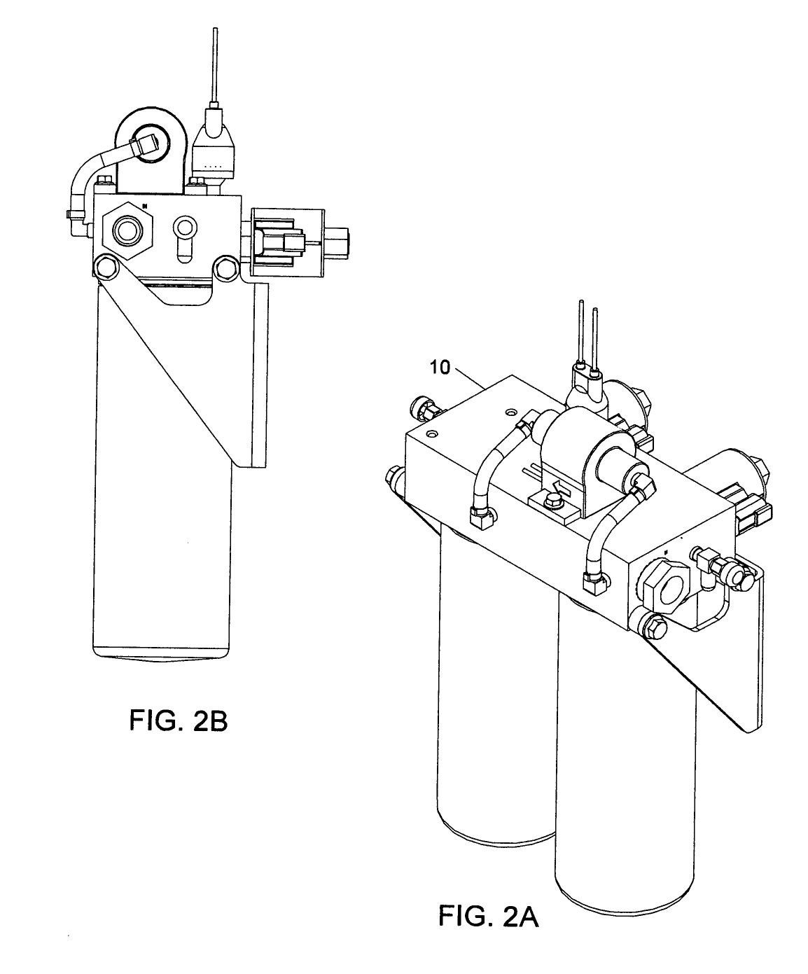

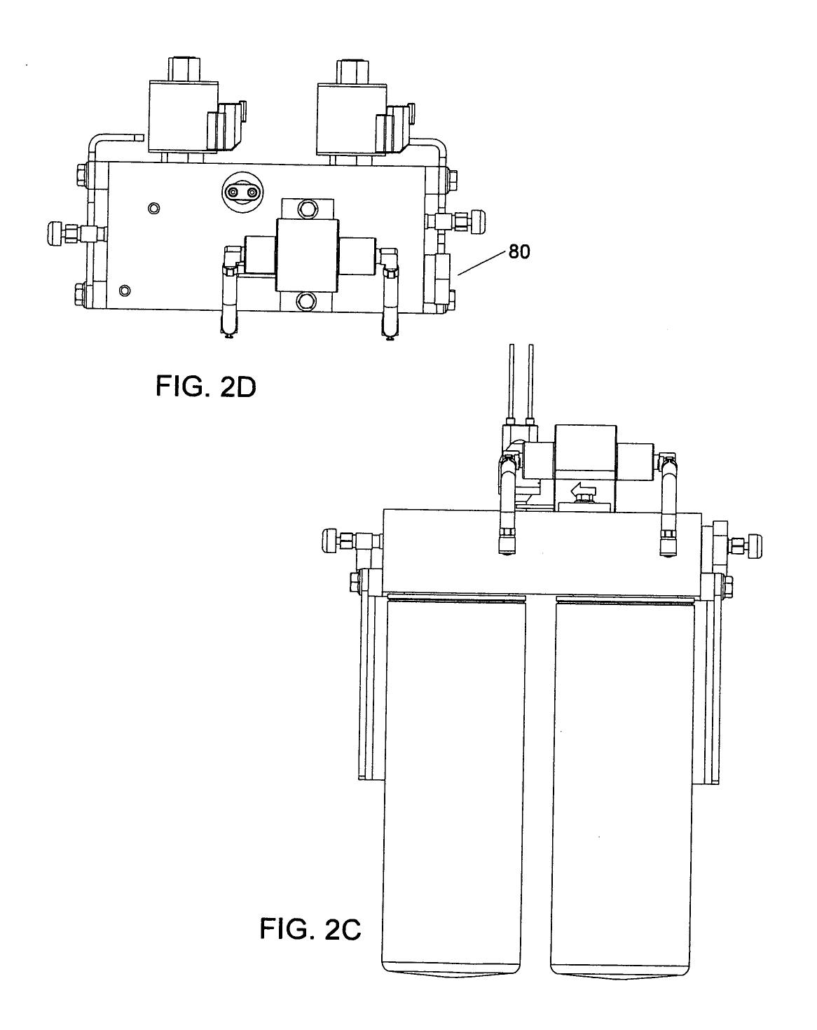

FIG. 1 depicts a first embodiment of the filter switching apparatus with filters attached. In the figure, manifold (routing block) 10 has attached to it a priming pump on the top, two fuel filters on the bottom, and solenoid valves on the back surface. Fuel channels are visible in the routing block. FIG. 2 is an engineering drawing depicting detailed aspects of the first embodiment.

FIG. 3 is schematic depicting configuration of the filters and valves in an embodiment of the invention having two filters. Filter and manifold assemble 250 receives fuel from fuel tank 200 via fuel supply line 220. During operation of the engine, valves 40 and 50 determine which of filters 20 and 30 the fuel flows through. Pressure (or vacuum) sensor 60 detects when a filter is becomes clogged. When a filter is no longer usable, valves 40 and 50 divert the fuel flow through the unclogged backup filter without having to stop the engine to change filters. When changing filter 20, the engine is turned off and bleed valve 110 is opened. The clogged filter is removed, and a new filter is installed. Air purge (priming) pump 130 is then activated until the fuel escaping the bleed valve is free of air. Then the pump is turned off, the bleed valve is closed, and the device is again ready to support normal engine operation. Replacement of filter 30 proceeds similarly. Check valve 230 prevents reverse fuel flow when filters are replaced. The check valve may be incorporated into the pump 130.

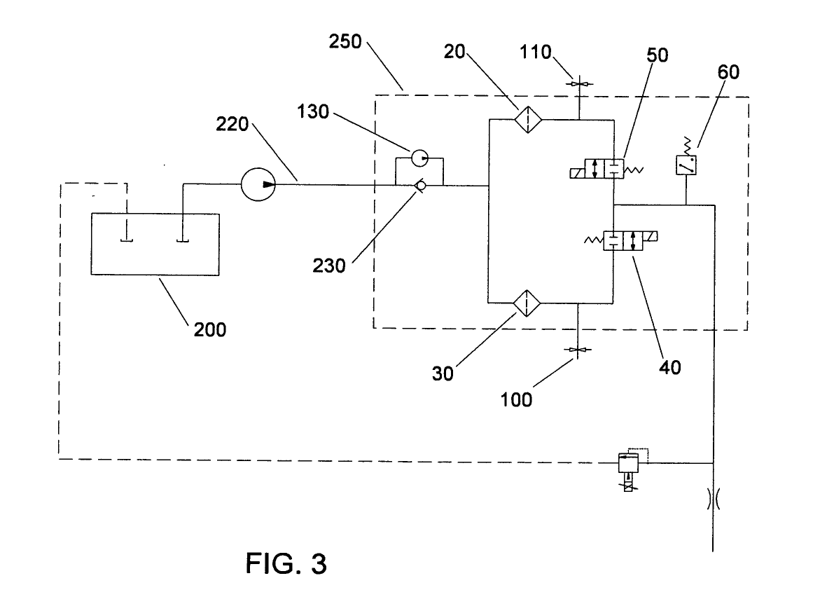

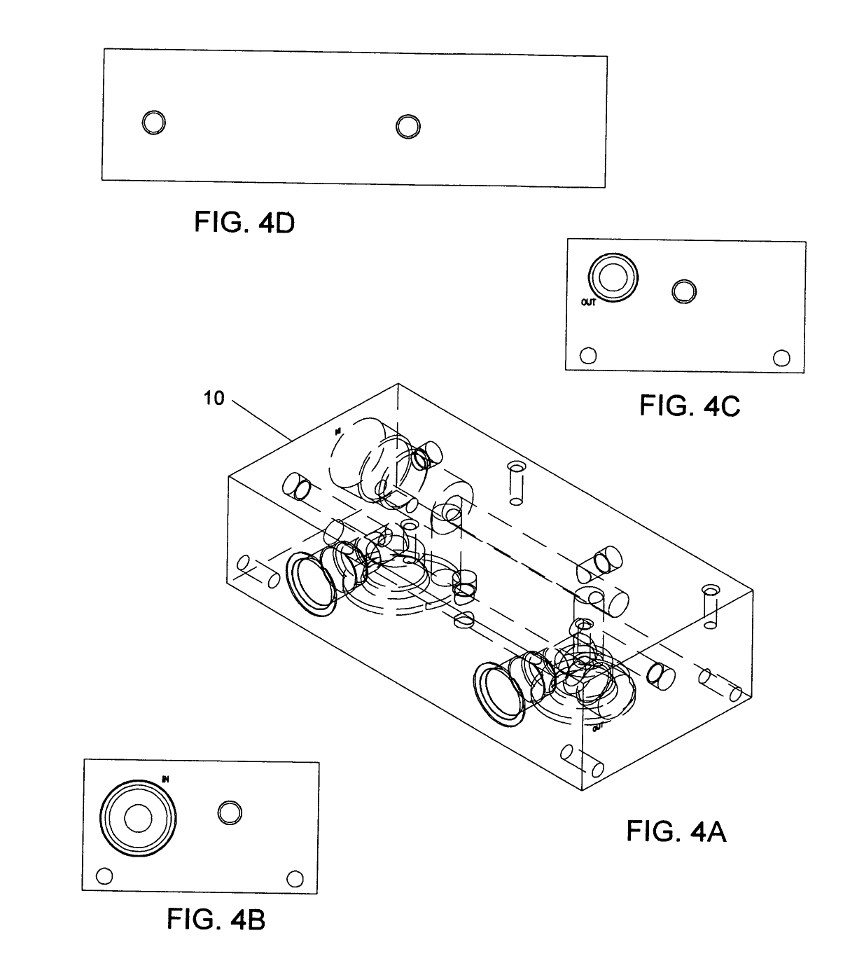

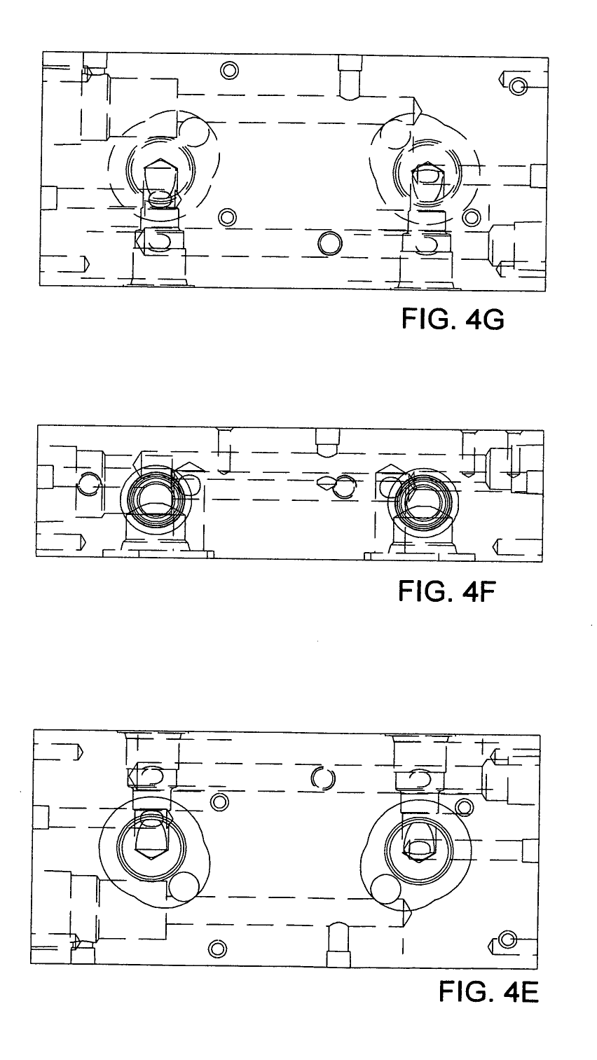

FIG. 4 is an engineering drawing of a first embodiment of the manifold 10 configured for horizontal valves. The block is made of machined aluminum, and has dimensions of about 2.25 inches tall, 4 inches in depth, 8.5 inches in width.

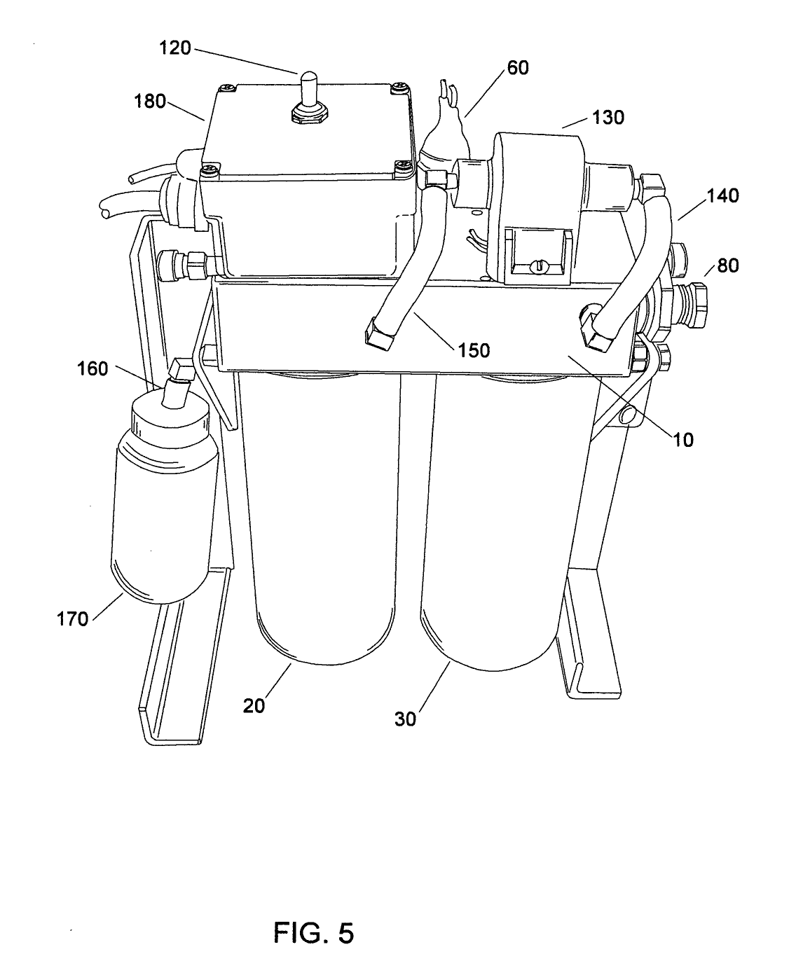

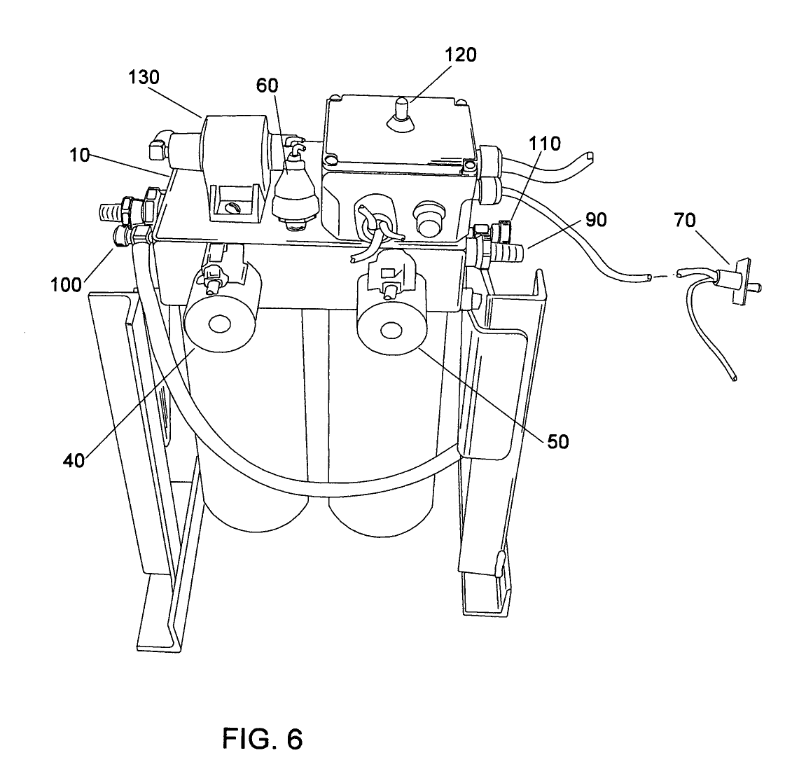

FIG. 5 is a view of a working prototype of a first embodiment of the invention mounted on an exhibit stand and FIG. 6 is a reverse angle view of a working prototype of a first embodiment of the invention mounted on an exhibit stand. Routing block 10 accommodates a first filter 20 and a second filter 30. Unfiltered fuel enters the routing block at fuel inlet 80 and filtered fuel exits at fuel outlet 90. Solenoid valves 40, 50 control the routing of fuel to either the first filter or the second filter. Fuel supply line sensor 60 (in this case a vacuum sensor) detects the vacuum level in the fuel supply line. The filter switching control unit and monitoring unit are incorporated together as 70, which may be located in the cab of a semi truck. In the embodiment shown, the monitoring unit comprises a single warning light that turns on when the vacuum detected by sensor 60 exceeds 7. If the warning light stays on consistently, the operator may use the filter switching control unit (which in this embodiment comprises a single on/on switch) to switch the operating filter from the first filter to the secondary filter without leaving the cab.

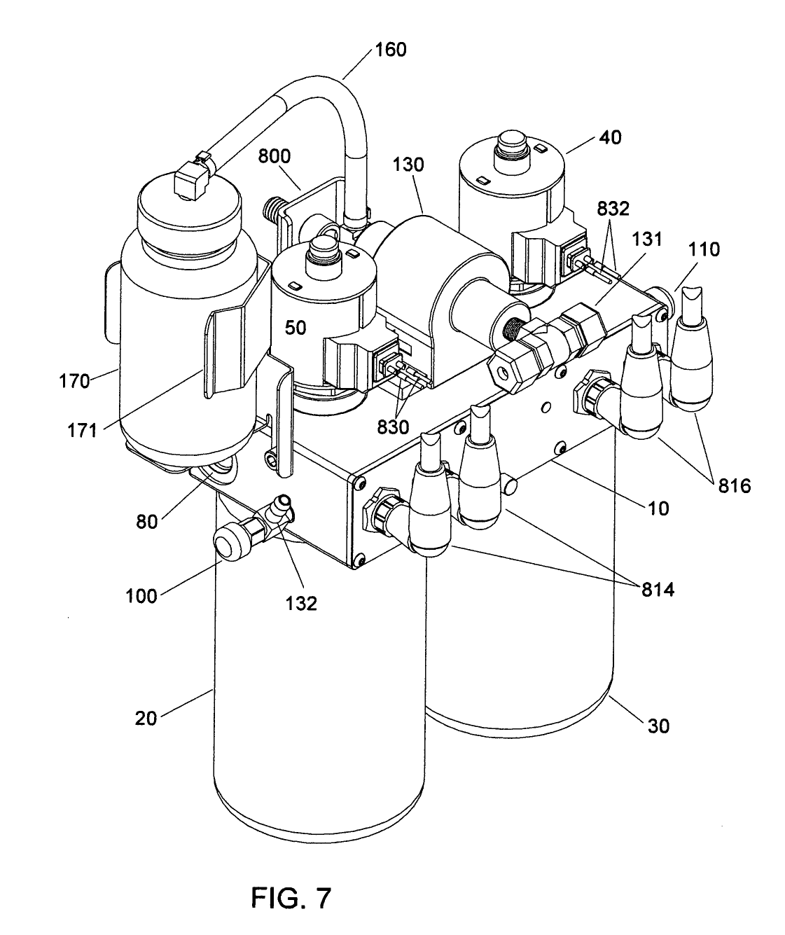

Replacing a clogged filter with a new one is a manual operation. With the engine off, the clogged filter is removed and a new filter is screwed onto the routing block 10. Optionally, both filters may be replaced at the same time. With the new filter(s) in place, bleed valves 100, 110 are opened. A check valve prevents fuel from flowing back to the fuel tank. Spring-loaded pressure switch 120 engages primer pump 130. Fuel flows through passageway (hose) 140 to pump 130 and then to the filters through passageway (hose) 150. Fuel is directed to one or both filters and the filters completely fill with fuel. Air and some fuel are released through the bleed valves and are routed though drain lines 160 to fuel collection container 170. Preferentially, container 170 is secured by a bracket or clamp (171 in FIG. 7). When fuel passing through the drain lines into container 170 is free of air, the pressure switch is released and the pump is turned off. The bleed valves are closed and the unit is again ready for operation with a secondary filter at the ready.

Control box 180 from the prototype shown in the first embodiment may be replaced by a wiring harness, though pressure switch 120 will be retained in some form.

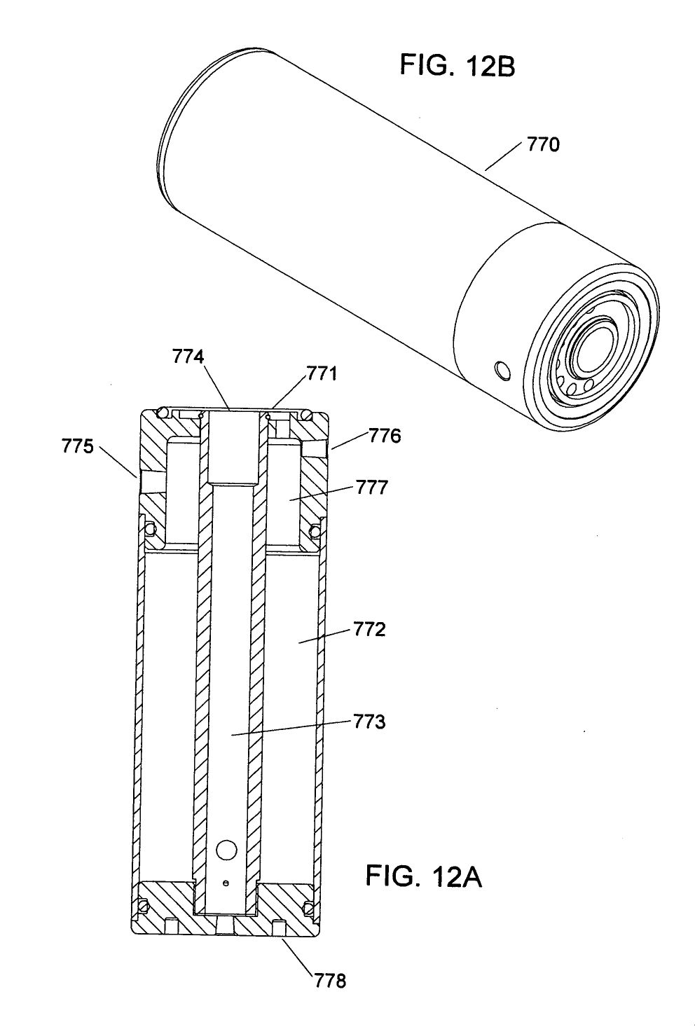

The apparatus may be factory installed, or it may be used to retrofit existing engines. When used as a retrofit, a cap (not shown) may be placed in position on the pre-existing fuel filter mount. The cap simply allows fuel to pass through from the inlet to the outlet without any filtering. Alternatively, an air separator as shown in FIG. 12 may be placed in position on the pre-existing fuel filter mount. Such an air separator removes unwanted air from the fuel. The switching apparatus is mounted in an available position using brackets or other means, and is connected into the fuel line.

In practice, many diesel engines are designed to have two fuel filters. A 20 micron filter initially removes larger particulates and a 7 micron filter removes smaller particulate matter. The fuel pump is typically interposed between the two filters. In such a configuration, it is desirable to substitute the present filter switching device for each of the original factory installed filters. In such a case, the priming pump may be eliminated on one of the manifold assemblies (typically the secondary) by routing hoses from a single pump to all four filters.

The configuration of the various components is an important aspect of the invention. The routing block, with a fuel inlet on one side and a fuel outlet on the other side, allows the electric valves to be positioned at right angles to the general flow of fuel. The valves may be positioned on the side of the block as in the first embodiment. In a presently preferred second embodiment, the valves are positioned on top of the block to reduced space requirements in an engine compartment. This arrangement is elegantly simple, provides easy access to various components for maintenance, and requires a minimal amount of space. Also, the general design allows for scalability to three or more filters.

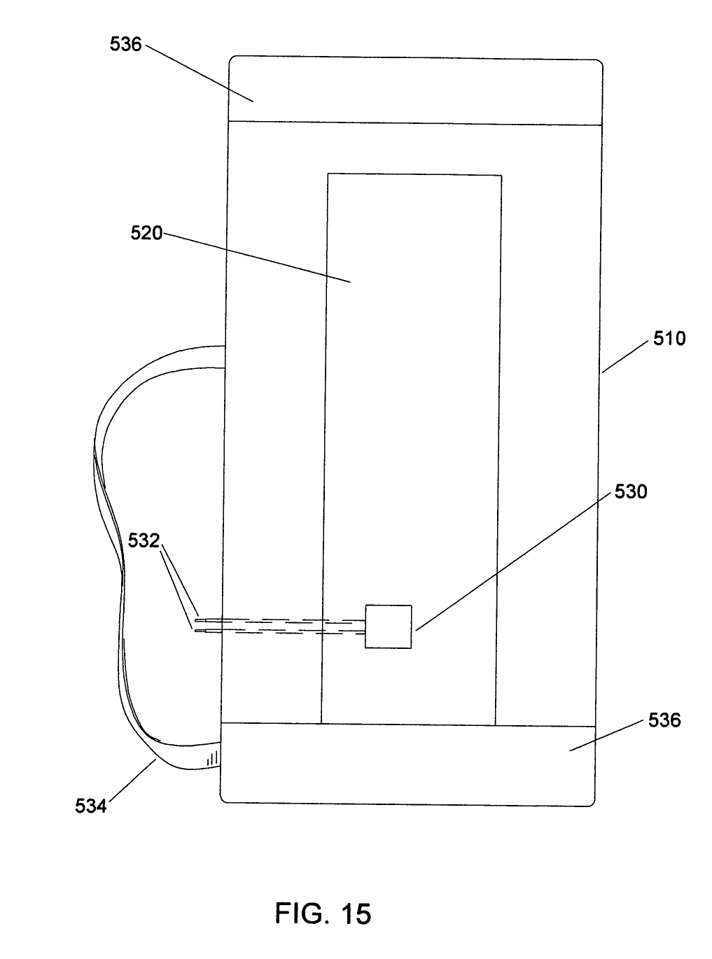

Another important aspect of the invention is a heater system that is useful in cold weather. Since the secondary filter does not actively have fuel running through it, it may become clogged or frozen in sub-zero temperatures. To keep the secondary filter ready for switching at any time, one or both filters may be separately covered by an insulated blanket. Referring now to FIG. 15, the heating blanket 510 is made of flexible waterproof and oil resistant material. The blanket includes an electric heating belt 520. The heating belt is typically made of molded fiberglass, and is set to engage by a thermostat 530 below a certain temperature (preferably 80 degrees Fahrenheit in extremely cold weather). The thermostat may be set to turn off at around 110 degrees Fahrenheit. The blanket may be held in place with a strap 534 and is powered by wires 532. The blanket is dimension to cover the fuel filter, and is held together around the filter by a fastener such as Velcro® 536.

In addition to user-controlled filter switching as described, the control unit can also be set to actuate the valve system after a certain period of operating time elapses since the filter was last replaced. Alternatively, the control unit can be set to an automatic mode, where the control unit switches the filters based on signals from the pressure sensor.

The monitoring unit may comprise a filter status display, and may be integrated with the filter switching control unit. The filter status display may communicate with the pressure sensor through wired or wireless means, displaying the operational status of the filters, which filter is currently designated as the “backup” filter, and if either filter is currently plugged or otherwise ineffective. The switching control unit may incorporate a filter status display. The switching control unit may include a plurality of buttons for controlling the optional filter status display, for designating which filter is to be the backup filter, for initiating a priming sequence on either filter, and for stopping a priming sequence.

The apparatus may further comprise a heater block for heating the fuel passing through the unit.

While the figures show a system with two fuel filters, the same basic design can be expanded to accommodate three or more filters simply by expanding the manifold and adding additional valves and other components as necessary.

The valve system may be implemented with a separate electric solenoid rod valve for each filter, as shown in the first embodiment. The valves attach to the manifold and operate in conjunction with the passages in the manifold so that only one filter at a time is operable, while the other filter or filters are either in a backup position or a clogged state. Parker and Hydroforce both manufacture suitable valves.

While solenoid valves that turn fuel flow on an off with the in-and-out motion of a rod or the like are currently preferable, the invention may also be implemented with valves that control flow by rotation. In such a case, electric motors are required instead of solenoids.

The primer pump (air purge pump) is used to remove unwanted air from the filter and fuel passageways. Once the filter (or filters) are replaced, the primer pump is activated until fuel from bleed valves is free of air. This may be monitored visually by the person replacing the filter. The pump is then turned off.

With a new unclogged fuel filter, a vacuum sensor in the fuel supply line will read about 2 during normal engine operation and about 4.5 under heavy acceleration. As a filter becomes clogged, the reading in the fuel supply line will gradually increase. The filters should be switched when the reading reaches about 6-10 in the fuel supply line for an extended period. The engine operator may track the vacuum using the monitoring unit, which may be located in the cab of a diesel truck. The operator may set the filter switching control unit to automatically change filters at a designated sustained vacuum reading. The operator can also use the filter switching control unit to change filters at the push of a button.

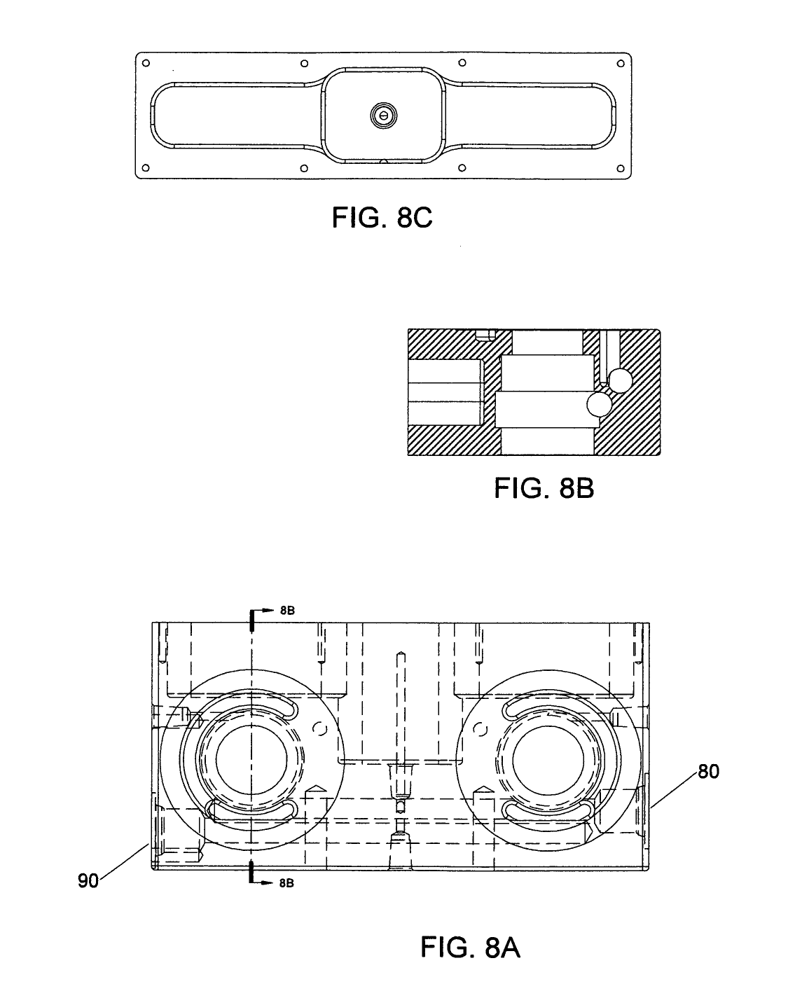

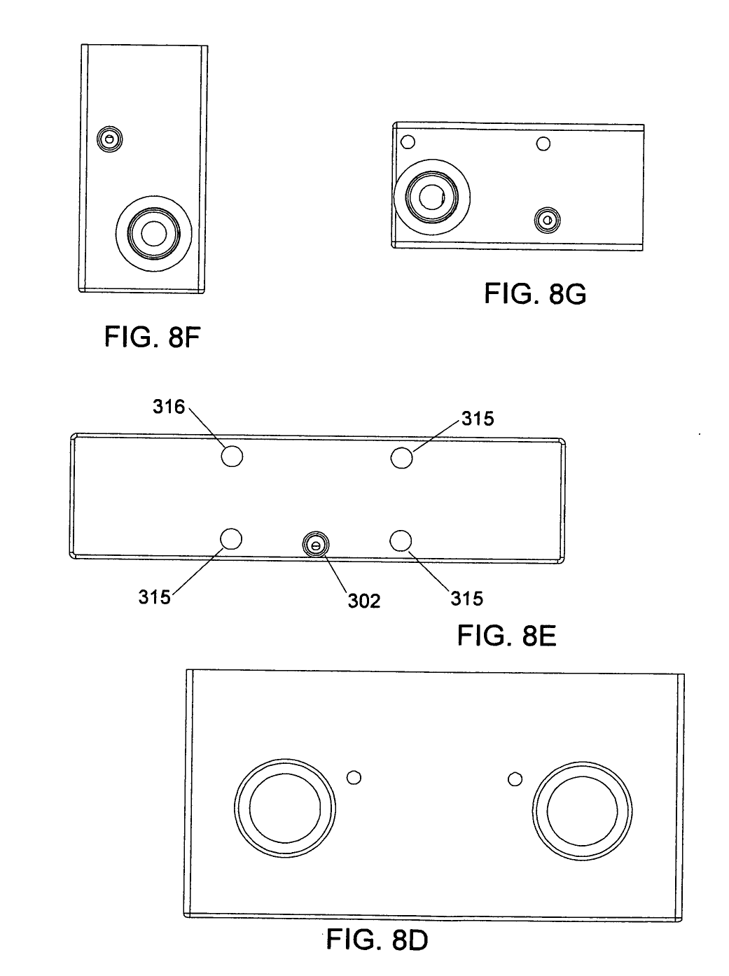

FIG. 7 depicts a second embodiment of the filter switching apparatus with filters attached. In the second embodiment, the valves are positioned vertically instead of horizontally. In addition to requiring less space, vertically positioned solenoid valves also act as check valves, eliminating the need for separate check valves required in the horizontal configuration. The second embodiment also includes an electronics bay in the routing block as described later in this disclosure. The second embodiment also includes cartridge sleeves as described later in this disclosure. The dimensions of the routing block are as shown in FIG. 8, i.e., about 2 inches tall, about 4 inches deep, and about 7.75 inches wide. It is highly desirable to limit the size of the manifold below these dimensions. Additionally, the second embodiment of the routing block can be nearly flush-mounted, since no components of the system extend behind the rear surface of the routing block.

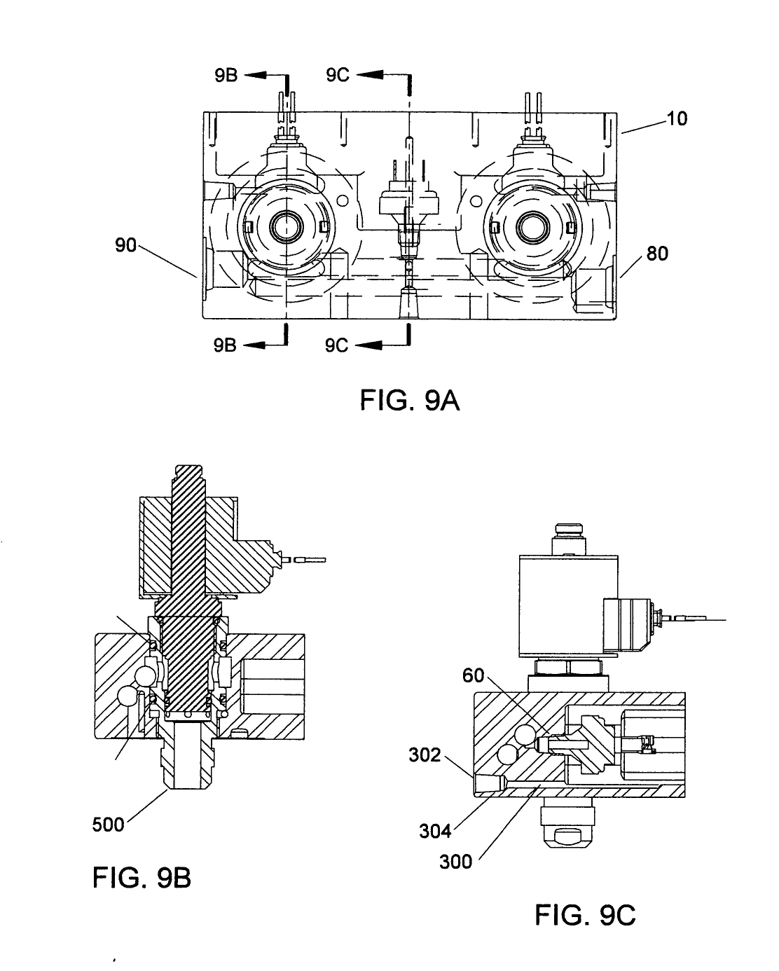

Referring now to FIG. 7, manifold or routing block 10 accommodates a first filter 20 and a second filter 30. Solenoid valves 40 and 50 are mounted on the top of the block and control the routing of fuel to either the first filter or the second filter. A primer pump 130 is also located on the top of the block. The manifold accommodates a fuel supply line sensor (60 in FIG. 9C) for detecting the vacuum level or pressure in the fuel supply line.

Unfiltered fuel enters the routing block at fuel inlet (90 on FIG. 8) and filtered fuel exits at fuel outlet 80 from the other side of the manifold. When priming replacement filter 20, bleed valve 100 is opened and the pump 130 is engaged by pushing switch 120, thereby creating suction to the filter via splitter or T-joint 131, a hose (not shown), connector 132, and a passageway within the manifold. Air is drawn out of the filter and replaced by fuel. After the air is drawn through the pump, it goes out via hose 160. One the filter is full of fuel, there will be no more air passing through hose 160 (just fuel) and the pump is disengaged.

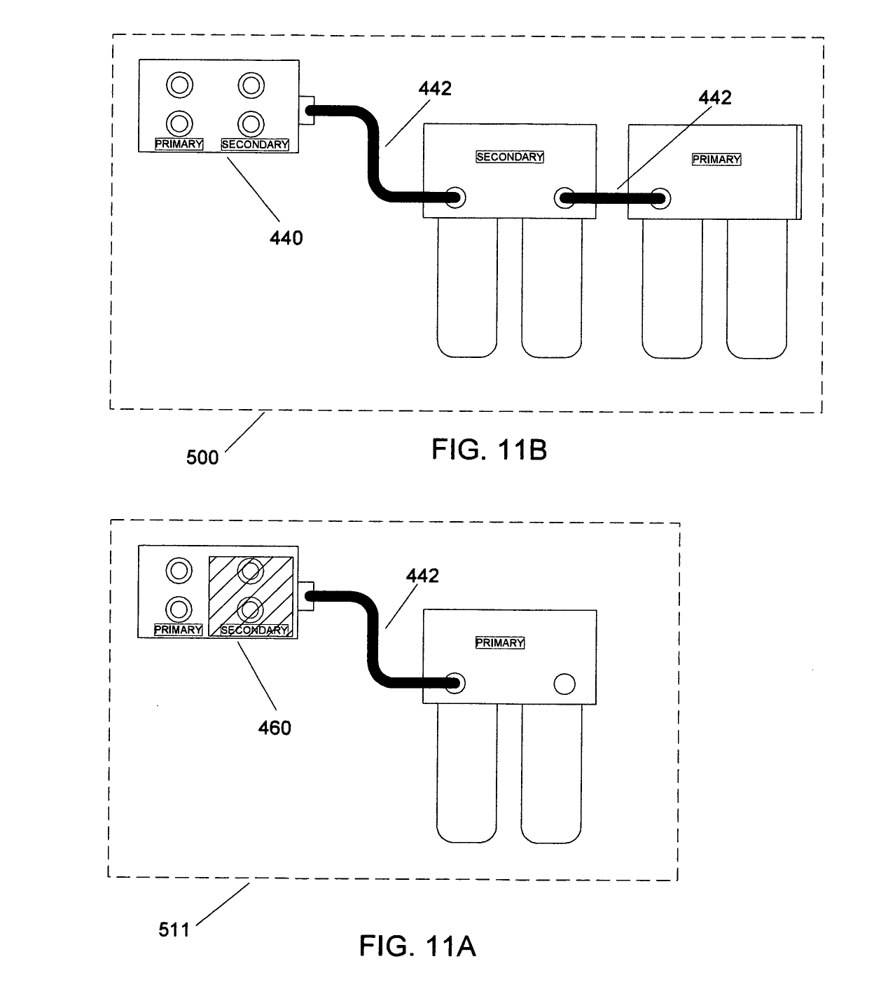

Still referring to FIG. 7, the manifold is designed to define and house an electronics bay located behind removable electronics bay cover 810. The electronics bay is a watertight enclosure that contains components of the filter switching control and monitoring unit. The electronics bay is used to access the vaccuum/pressure switch (60 in FIG. 9C). In addition to switch 60, the electronics bay houses a circuit board that communicates with the vacuum/pressure switch 60, valves 40 and 50, pump activator switch (822 on FIG. 14), filter status indicator lights (818 and 820 on FIG. 14), operator's panel (440 or 460 in FIG. 11) to monitor the filter status and control the valves. If other components requiring electronics (e.g., heaters) are incorporated into the system, these electronics may also be house in the bay. Extending from the front of the cover 810 are electrical connections 814 that are wired to communicate with electrical connections 830 on first valve 40, and electrical connections 816 that are wired to communicated with electrical connections 832 on second valve 50. The shape and dimension of the bay 810 in this embodiment are shown in FIGS. 8 and 9A. The electronics bay is kept watertight by a gasket (not shown) between the manifold 10 and the electronics bay cover 810. Pressure within the electronics bay is equalized via one (or more) air passageway 300 and port 302 (both shown in FIG. 9C). A stone filter (304) prevents water from getting into the bay via the passageway 300.

FIG. 8 is an engineering drawing of a second embodiment of the manifold. The block is preferably machined from aluminum or other lightweight metal. All fuel channels, air passageways, and openings for mounting components (valves 40 and 50, pump 130, cover 810, etc.) are machined perpendicular to the faces of the manifold.

FIG. 9A is an engineering drawing of the second embodiment of the manifold. FIG. 9B is a cross-sectional view of a manifold/sleeve/valve assembly. FIG. 9C is a sectional view of the manifold showing the location of the vacuum/pressure sensor and pressure equalizing port.

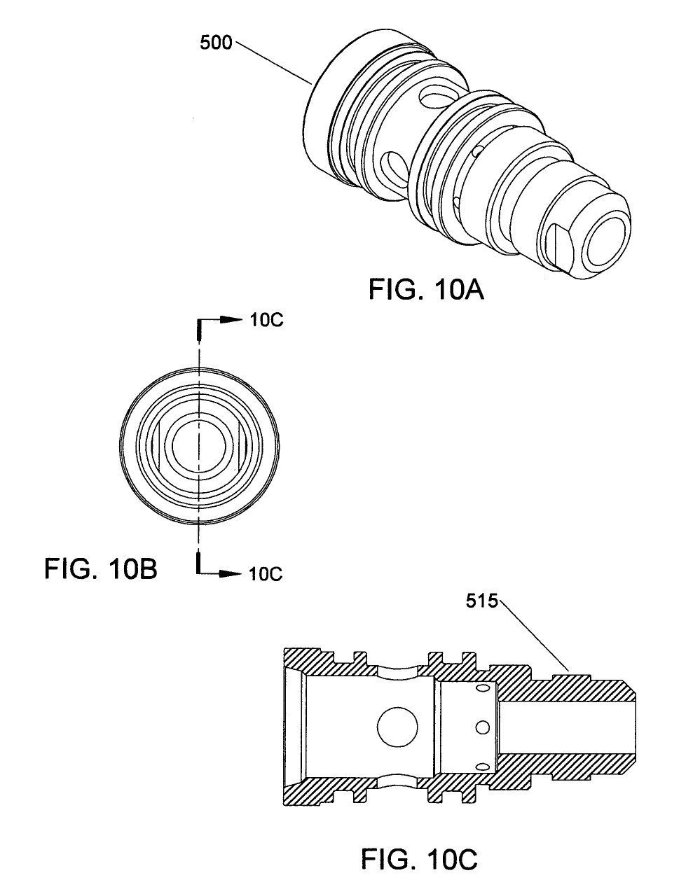

The valves are the only parts within the manifold that have significant mechanical movement. To allow the use of a smaller manifold block, cartridge sleeves may interposed between the manifold and the valves as in the second embodiment. FIG. 10 is an engineering drawing of an embodiment of a cartridge sleeve. The sleeves are fastened into the manifold, e.g. by threads. The cartridge sleeve is made of corrosion-resistant metal such as stainless steel. O-rings (510 in FIG. 9B) provide a tight seal. Filters attach to the manifold assembly via threading (515 in FIG. 10) on the cartridge sleeve.

FIG. 11 shows schematics of embodiments of filter switching control units for use in trucks, such as semis. The first configuration 500 may be used when two filter switching units are employed for one engine, and the second configuration 510 may be employed when only one filter switching unit is employed for an engine. In both cases, operator's panel 440 or 460 is installed in the cab of the truck and connected to the filter switching units by 3-wire cables 442 as shown. In the first configuration, the operator panel 440 has indicator light/switches for each of the two filters in the two sets of switching apparatuses (four filters total). Each light/switch has three indicator conditions: off (standby), green (filter on and OK) and red (clogged filter). If a filter is clogged, the operator simply has to push the button for the other filter on the switching unit and he or she is good to go. In the second configuration, indicator conditions and switching operation is the same.

FIG. 12 depicts an air separator 770. In a retrofit, the air separator may be installed instead of a cap in the place of the factory fuel filter mount(s). Fuel enters the separator at inlet 771 and passes through chamber 772 and chamber 773 before exiting the separator at outlet 774. Air collects in chamber 777. When air fills the top of chamber 777, sensor 775 alerts the operator (e.g., by a blinking light in the cab). The collected air is released by bleed valve 777. The bottom of the separator has specially machined openings 778 so that a tool (not shown) installs and aligns the separator at the proper tightness while exposing the bleed valve for easy access. Once the separator is in place, there is typically no reason to ever remove it.

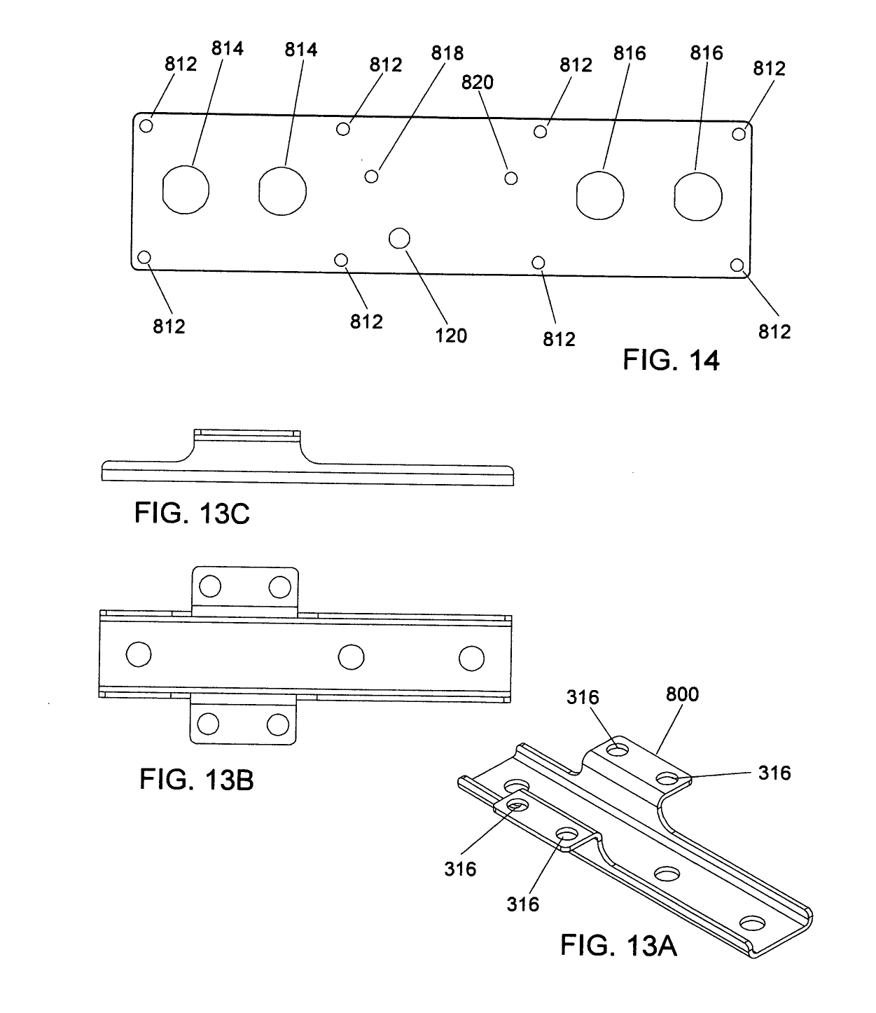

FIG. 13 depicts a mounting bracket 800 for flush mounting the device in the engine compartment of a vehicle. Holes in the 316 bracket are designed to match pre-drilled holes (315 in FIG. 8) in the manifold.

FIG. 14 is a depiction of and embodiment of the cover of the electronics bay. Bay cover 810 is attached to the manifold by screws or bolts 812. Openings for valve control circuitry 814 and 816 allow communication between electronics in the bay and the valves. Indicator lights 816 and 818 show the status of the two filters using the same codes as the operator's panel. Pressure switch 120 or equivalent operates the primer pump for filter replacement. Though not shown, the bay cover may also have openings and/or mounting for other equipment including heater cables and/or system cables for communication with operator's panel or another switching apparatus.

In one aspect, the invention is a manifold, a first preferred embodiment of which is shown in FIG. 4 and a second preferred embodiment of which is shown in FIG. 8. The manifold is preferably machined aluminum. The manifold includes fuel passages for routing fuel to the filters, as well as passageways for operation of the primer pump.

In another aspect, the invention is a filter switching apparatus for diesel fuel applications, the apparatus comprising a fluid routing block or manifold on which a first filter and one or more secondary filters may be mounted, a valve system to select fuel flow through either the first or secondary filters, a fuel supply line sensor, a control unit, a monitoring unit, and a filter priming pump.

In another aspect, the invention is a operators panel for monitoring filter status and switching filters from the cab of a semi truck.

In another aspect, the invention is a cartridge sleeve for interposing between the manifold and the valves.

In another aspect, the invention is a filter switching apparatus for diesel fuel applications, the apparatus comprising: a fluid routing block on which a first filter and one or more secondary filters may be mounted; a valve system comprising two or more valves to select fuel flow through either the first or secondary filters;cartridge sleeves interposed between each of the valves and the fluid routing block; a fuel supply line sensor; a filter priming pump; and an operator's panel. The sleeves are comprised of a corrosion resistant metal. The operator's panel may be comprised of a combination indicator light and a switch corresponding to each filter. Preferably The depth of the fluid routing block is less than about 4 inches and the width of the fluid routing block is less than about 8 inches. Preferably, the fluid routing block is flush mounted in the engine compartment of a semi truck. The apparatus may further comprise a removable electronics bay cover, where the fluid routing block together with a removable electronics bay cover define a watertight electronics bay. The fuel supply line sensor may be accessed vie the electronics bay. The apparatus may further comprise a fuel inlet on one side of the fluid routing block and a fuel outlet on the opposite side of the fluid routing block. The valves are preferably actuated by solenoids. The valves may be spool valves or poppet valves. Alternatively, the valves may be actuated by electric motors. The apparatus may further comprise an air separator. The electronics bay cover may include mountings for filter status indicator lights and/or a priming pump activator switch. The apparatus may further comprise a heating blanket.

The apparatus is especially useful for diesel trucks such as semis or pickups, or for electrical generators. The apparatus may be used and adapted for filters of different sizes.

While embodiments and applications of this invention have been shown and described, it would be apparent to those skilled in the art having the benefit of this disclosure that many more modifications than mentioned above are possible without departing from the inventive concepts herein. Implementation of the invention may include variations and permutations of features selected from either or both of the two embodiments shown in detail of this disclosure. The invention, therefore, is not to be restricted except in the spirit of the appended claims.

What is claimed is:

1. A filter switching apparatus for diesel fuel applications, the apparatus comprising:
a fluid routing block on which a first filter and one or more secondary filters may be mounted;
a valve system comprising two or more valves to select fuel flow through either the first or secondary filters;
cartridge sleeves interposed between each of the valves and the fluid routing block;
a fuel supply line sensor;
a filter priming pump;
and an operator's panel.

2. The apparatus of claim 1, where the sleeves are comprised of a corrosion resistant metal.

3. The apparatus of claim 1, where the operator's panel is comprised of a combination indicator light and a switch corresponding to each filter.

4. The apparatus of claim 1, where the depth of the fluid routing block is less than about 4 inches and the width of the fluid routing block is less than about 8 inches.

5. The apparatus of claim 1, where the fluid routing block is flush mounted in the engine compartment of a semi truck.

6. The apparatus of claim 1, further comprising a removable electronics bay cover, where the fluid routing block together with a removable electronics bay cover define a watertight electronics bay.

7. The apparatus of claim 6, where the fuel supply line sensor is accessed vie the electronics bay.

8. The apparatus of claim 1, further comprising a fuel inlet on one side of the fluid routing block and a fuel outlet on the opposite side of the fluid routing block.

9. The apparatus of claim 1, where the valves are actuated by solenoids.

10. The apparatus of claim 9, where the valves are spool valves.

11. The apparatus of claim 9, where the valves are poppet valves.

12. The apparatus of claim 1, where the valves are actuated by electric motors.

13. The apparatus of claim 1, further comprising an air separator.

14. The apparatus of claim 6, where the cover includes mountings for filter status indicator lights.

15. The apparatus of claim 6, where the cover includes a mounting for a priming pump activator switch.

16. The apparatus of claim 1, further comprising a heating blanket.
